(19) United States
(12) Patent Application Publication
(10) Pub. No.: US 2026/0067375 A1
(43) Pub. Date: Mar. 5, 2026

(54) SYSTEM AND METHOD FOR TRANSPORTING MACHINE LEARNING MODELS IN A DECENTRALIZED NETWORK

(71) Applicant: Booz Allen Hamilton Inc., McLean, VA (US)

(72) Inventors: Michael Anthony DeLeo, Cranberry TWP, PA (US); Ryan Christopher Montesi, Washington, DC (US); Dylan Stewart Kaplan, Denver, CO (US)

(73) Assignee: Booz Allen Hamilton Inc., McLean, VA (US)

(21) Appl. No.: 18/824,277

(22) Filed: Sep. 4, 2024

(51) Int. Cl. H04L 67/00; G06N 20/00; H04L 67/63

(52) U.S. Cl. CPC H04L 67/34; H04L 67/63; G06N 20/00

(57) ABSTRACT

Provided are systems, methods, and computer program products for delivery of machine learning models within a computing network including memory including object storage locations configured to store model objects, route objects, and station objects, a model storage device configured for storing machine learning models, and a processor configured with a class interface module and a class data aggregator module. The processor is configured to execute program code that, when executed, will cause the processor to execute the class interface module and the class data aggregator module to generate a model object based on a model class, generate a station object based on a station class, generate a route object based on a route class, extract the model object including parameters of a machine learning model from a first storage location, generate a model data package, and transmit the model data package to a computing node.

### FIELD

The subject matter disclosed relates generally to computer networking and machine learning model development, and, in some embodiments, to methods, systems, and non-transitory computer readable mediums encoded with program code for transporting machine learning models in a decentralized network. In some embodiments, methods, systems, and non-transitory computer readable media may relate to managing, transporting, and/or storing a machine learning model, wherein the managing, transporting, and/or storing of the machine learning model is agnostic to a platform executing on a target computing device.

### BACKGROUND INFORMATION

In Machine Learning Operations (MLOPs), various machine learning model ecosystems and/or frameworks may be used to develop and build various machine learning models. MLOPs is a process of designing, training, storing and/or serving machine learning models. Typical MLOPs solutions serve specific niches of AI solutions. Thus, many current MLOPs solutions are inflexible to machine learning model integration and cross-platform sharing of machine learning models.

In many instances, current practices for MLOPs in machine learning model deployment, storage and inference typically rely on such inflexible machine learning model frameworks that may restrict integration of models and MLOPs. For example, teams that develop and deploy machine learning models must configure models and frameworks so that the machine learning models can operate properly in different software environments. Each machine learning model framework and environment may require special considerations and/or configuration of machine learning models. Configuration of machine learning models to make various model types work properly in different software environments and/or frameworks may add significant time and effort to deployment and delivery, thus reducing efficiency of machine learning model development and increasing the presence of software bugs and issues for cross collaboration of machine learning models.

### SUMMARY

Embodiments may relate to a computing system for delivery of machine learning models within a computing network. The computing system may include memory that includes object storage locations. The object storage locations may be configured to store model objects, route objects, and station objects. The computing system may include a model storage device which may be configured for storing machine learning models. The computing system may include a processor configured with a class interface module and a class data aggregator module. The processor may be configured to execute program code that, when executed, may cause the processor to execute the class interface module and the class data aggregator module to generate a model object based on a model class. The model object may include parameters of a machine learning model. The class data aggregator module may configure the processor to store the parameters of the machine learning model in the model object. The class interface module may configure the processor to store the model object in a first object storage location in the memory. The program code may cause the processor to generate a station object based on a station class. The station object may include parameters of a computing node. The class data aggregator module may configure the processor to store the parameters of the computing node in the station object. The class interface module may configure the processor to store the station object in a second object storage location in the memory such that the model object is configured for storage on the computing node. The program code may cause the processor to generate a route object based on a route class. The route object may include parameters of a transmission path from the model storage device to the computing node. The class data aggregator module may configure the processor to store the parameters of the transmission path in the route object. The class interface module may configure the processor to store the route object in a third object storage location in the memory such that the model object is configured for transmission to the computing node. The program code may cause the processor to extract the model object including the machine learning model parameters 116 from the first storage location. The class interface module may configure the processor to retrieve the model object, the station object, and the route object. The program code may cause the processor to generate a model data package. The data aggregator module may configure the processor to package the model class, station class, and route class into the model data package. The program code may cause the processor to transmit the model package to the computing node.

Embodiments may relate to a system for managing, transporting, and executing machine learning models in a computing network. The system may include a first model processing device. The system may include memory configured for storing model objects, route objects, and station objects. The system may include a model storage device configured for storing machine learning models. The system may include a processor configured with a class data aggregator module and a class interface module. The processor may be configured to execute program code that, when executed, may cause the processor to execute an application programming interface (API). The program code may cause the processor to register model data corresponding to a machine learning model via the API to generate a model object. The model object may be stored in the first storage device. The program code may cause the processor to push the model object to a container registry executing on a source computing device by transmitting the model object using a registry route. The registry route may cause the model object to be automatically transmitted to the container registry independent of a configuration of the container registry. The program code may cause the processor to pull the model object from the container registry executing on the source computing device using a registry route. The registry route may cause the model object to be automatically downloaded to at least one processor of the first model processing device. The program code may cause the processor to transmit the model object to a second computing device using a component interface. The component interface may cause the model object to be automatically transmitted to the second computing device independent of an operating system executing on the second computing device. The program code may cause the processor to write the model data associated with the model object to a second model storage device of the second computing device based on a station interface. The station interface may cause the second computing device to store the model data independent of a machine learning model storage application executing on the second computing device.

Embodiments may relate to a method for managing and transporting machine learning models in a decentralized computing network. The method may include registering a machine learning model to generate a model object storing model data associated with the machine learning model. The machine learning model may be developed in a source framework. The method may include transmitting the model object to a container registry. The method may include transmitting the model object to a first remote computing device. The first remote computing device may execute a destination framework. The model object may be automatically compatible with the destination framework. The method may include streaming the model object to a storage device of a second remote computing device. The model object may be stored independent of a machine learning model storage application executing on the second remote computing device.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for managing, transporting, and/or storing machine learning models in a platform-agnostic manner as disclosed herein;

FIG. 2 is a flow diagram of an exemplary method for managing, transporting, and/or storing machine learning models in a platform-agnostic manner as disclosed herein;

FIG. 3 is a diagram of an exemplary system environment for managing, transporting, and/or storing machine learning models in a platform-agnostic manner as disclosed herein;

FIG. 4 is a diagram of an exemplary system configuration for managing, transporting, and/or storing machine learning models in a platform-agnostic and decentralized network as disclosed herein;

FIG. 5 is a diagram of an exemplary architecture of components of a computing device and/or system as disclosed herein;

FIG. 6 is a diagram of an exemplary sequence of steps for saving and/or loading machine learning models in a decentralized network; and

FIG. 7 is a diagram of exemplary components of a computing device and/or system as disclosed herein.

### DETAILED DESCRIPTION

In accordance with exemplary embodiments, platform-agnostic systems may be used for executing, managing, transporting, and/or storing machine learning models within a network from any machine learning model registry and/or file storage system. According to some embodiments, machine learning models and/or machine learning capabilities may be delivered to client devices and/or user devices regardless of machine learning ecosystems and/or machine learning platforms executing on the client devices and/or user devices. In this way, embodiments disclosed herein may be platform-agnostic.

Platform-agnostic may refer to a design and/or construction of embodiments disclosed herein, such that embodiments are not coupled to any specific computing environment, platform or computing system and embodiments may execute equally across multiple platforms without errors and/or failures caused by cross-platform inconsistencies and/or compatibilities. Embodiments may be platform-agnostic as a result of the design and/or construction of software and/or hardware of disclosed embodiments. Platform-agnostic embodiments may be resilient, flexible, and cross-compatible such that platform-agnostic embodiments may be executed on any computing device (e.g., client devices, edge devices, servers, etc.) and/or any machine learning platform without specific configuration by a user and without failure. Platform-agnostic embodiments may be executed on any computing device and/or any machine learning platform without specific configuration due to the design and/or structure of the software and/or hardware.

Design and/or structure of software and/or hardware of various embodiments may include a model class, a station class, and a route class. The model class, the station class, and the route class may be instantiated in memory by a processor to generate a model object, a station object, and a route object. The model object, the station object, and the route object may contain data and/or properties of various systems such that a processor may execute, manage, transport, and/or store machine learning models within the various systems without having to specifically configure the various systems and/or platforms executing on the various systems. In this way, the model class, the station class, and the route class provide a common interface between machine learning models and various platforms and may also server as storage mechanisms for various properties of machine learning models and/or machine learning ecosystems. With the model class, the station class, the route class, and other modules, a processor may be specifically configured to generate model objects, station objects, and route objects that facilitate platform-agnostic execution, management, transportation, and storage of various types of machine learning models. Platform-agnostic execution, management, transportation, and storage of machine learning models may provide a number of benefits.

Embodiments disclosed herein may improve MLOPs. MLOPs may refer to a process of designing, training, storing and/or serving machine learning models. Embodiments may provide for using and/or connecting any machine learning model on any storage system. Such embodiments provide flexibility of using machine learning models on multiple platforms and/or computing devices where previous and/or current MLOPs solutions have failed.

Embodiments may allow users to store machine learning models in disparate, novel and unique storage locations. For example, embodiments may allow a user to store machine learning model files in any computing system that satisfies requirements of interfaces and/or classes (e.g., model class, station class, route class, etc.) provided in exemplary embodiments. For example, embodiments may use a station class as a decentralized node to facilitate synchronization, and/or transportation of machine learning models by providing a common interface between machine learning models and storage locations, source computing devices, and/or destination computing devices. Using embodiments, a user may store machine learning models in various storage locations and/or storage platforms including, for example, a Docker® registry. Embodiments may provide a standardized model class that, when combined with a machine learning model (e.g., from a user), can be saved and easily transferred between platforms executing on different computing devices, including, but not limited to, storage platforms ranging from Amazon® Simple Storage Service (Amazon® S3) cloud storage to a local small form factor device. The ability to easily transport and store machine learning models between platforms executing on different computing devices may result in seamless deployment of machine learning models and/or seamless sharing of machine learning models with other teams, client devices, and/or user devices without requiring a user to configure or re-configure the machine learning models and/or platforms on which the machine learning models are executed and/or stored.

Embodiments may provide a transportation network for machine learning models that may connect with a model development framework used on a client device and/or user device without resulting in failures and/or requiring specific configuration by a user. Embodiments provide flexibility, efficiency, and simple integration over previous and/or current MLOPs solutions, offering a user a flexible system such that the user can decide where to send and/or store machine learning models without complicated configuration and without platform and/or system limitations.

Embodiments may provide users with tools to manage and deploy a wider range of machine learning models in various locations while requiring minimal dependencies on other platforms and/or frameworks, thereby allowing users to manage machine learning models and execute the machine learning models in any computing environment. Such embodiments may allow for transportation of a machine learning model between a machine learning model training platform, a storage location, and/or a destination computing device where the destination computing device is used to execute the machine learning model with an input to generate an inference. Embodiments may provide flexibility to repeat the transportation of a machine learning model between a machine learning model training platform, a storage location, and/or a destination computing device for various computing systems. In some instances, embodiments may automatically interface with external storage locations. Embodiments may allow users to add different computing devices to a network such that the computing devices may be interfaced with for the execution, management, transportation, and/or storage of machine learning models.

Embodiments provide software and/or hardware that may allow users to use machine learning models built with various machine learning model solutions and/or various machine learning model platforms through a single interface. For example, users may use various registry solutions with embodiments disclosed herein, thus offering greater flexibility for machine learning projects such that users may source existing machine learning models from different storage locations without additional configuration. Such embodiments provide improvements to computing systems for MLOPs and for management and transportation of machine learning models, providing interfaces that allow for automatic management and storage of machine learning models resulting in more efficient use of computing and/or storage resources.

Embodiments may provide for decentralized flexibility by enabling artificial intelligence model deployment in any computing location, thus reducing dependence on centralized servers and enhancing flexibility of AI model storage and retrieval. Embodiments may provide for secure storage and inference via a decentralized network. AI models may benefit from enhanced security, minimizing risk of data breaches and ensuring reliable AI inference. In this way, embodiments may mitigate risks associated with centralized computing systems while providing a scalable, secure, and flexible solution, ensuring reliable and efficient AI model deployment.

Embodiments may provide for self-managed systems such that users may leverage self-managed storage and inference, reducing operational complexities and allowing for more efficient utilization of resources. Embodiments may provide for low overhead by using minimal computing system resources, allowing embodiments to run efficiently in a wide range of computing environments, including resource-constrained environments. Embodiments may provide for a low adoption cost by seamlessly integrating with various MLOPs frameworks with minimal configuration.

Embodiments disclosed herein may improve the operation of a processor to execute, manage, transport, and/or store machine learning models in a platform agnostic manner using a variety of computing devices and platforms. Embodiments provide systems and methods to provide platform-agnostic execution, management, transportation, and/or storage of machine learning models not previously realized. Such improved operation of a processor results in more efficient MLOPs, more efficient use of computing resources and/or storage resources and reduces configuration requirements and system failure while increasing cross-platform flexibility and usability.

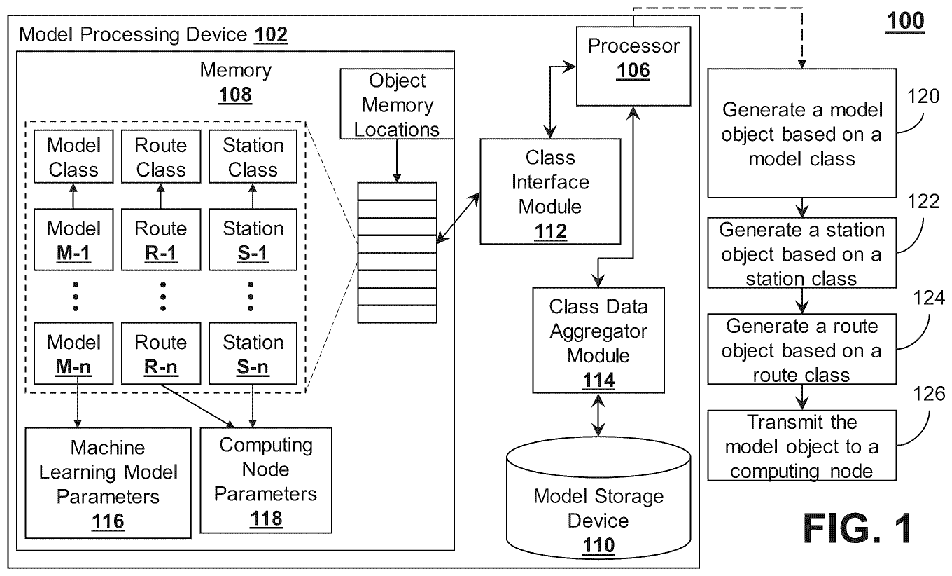

FIG. 1 shows a diagram of an exemplary system configuration for managing, transporting, and/or storing machine learning models in a platform-agnostic manner as disclosed herein. The various components of FIG. 1 may be implemented in and/or processed by a processor (e.g., a CPU) and/or on any number of distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a computing system 100 configured for managing, transporting, and/or storing machine learning models in a platform-agnostic manner. In some embodiments, computing system 100 may be configured for executing, managing, transporting, and/or storing machine learning models within a computing network. Computing system 100 may include model processing device 102, processor 106, memory 108, model storage device 110, class interface module 112, class data aggregator module 114, machine learning model parameters 116, computing node parameters 118, model objects M-1 to M-n (referred to individually as model object M and collectively as plural model objects M where appropriate), station objects S-1 to S-n (referred to individually as station object S and collectively as plural station objects S where appropriate), and route objects R-1 to R-n (referred to individually as route object R and collectively as plural route objects R where appropriate).

Computing system 100 may be configured for delivery of machine learning models within a computing network. Computing system 100 may include memory 108 including object storage locations configured to store model objects, route objects, and station objects. Computing system 100 may include model storage device 110 configured for storing machine learning models. Computing system 100 may include processor 106 configured with class interface module 112 and class data aggregator module 114. Processor 106 may be configured to execute program code that, when executed, may cause processor 106 to execute class interface module 112 and class data aggregator module 114. Execution of class interface module 112 and class data aggregator module 114 may configure processor 106 to generate model objects M (e.g., model objects M-1 to M-n) based on a model class. Model objects M may include parameters 116 of a machine learning model. Class data aggregator module 114 may configure processor 106 to store parameters 116 of the machine learning model in model object M. Class interface module 112 may configure processor 106 to store model object M in a first object storage location in memory 108.

Execution of class interface module 112 and class data aggregator module 114 may configure processor 106 to generate station objects S (e.g., station objects S-1 to S-n) based on a station class. Station object S may include parameters of a computing node. Class data aggregator module 114 may configure processor 106 to store parameters 118 of the computing node in station object S. Class interface module 112 may configure processor 106 to store station object S in a second object storage location in memory 108 such that model object M may be configured for storage on the computing node.

Execution of class interface module 112 and class data aggregator module 114 may configure processor 106 to generate route objects R (e.g., route objects R-1 to R-n) based on a route class. Route object R may include parameters of a transmission path (including parameters 118 of the computing node) from model storage device 110 to the computing node. Class data aggregator module 114 may configure processor 106 to store the parameters of the transmission path in route object R. Class interface module 112 may configure processor 106 to store route object R in a third object storage location in memory 108 such that model object M may be configured for transmission to the computing node(e.g., from model storage device 110 and/or a local computing node).

In some embodiments, class interface module 112 may be configurable by a user via processor 106 and/or user input to model processing device 102 to generate additional computing nodes using the station class (e.g., by generating additional station objects S). In some embodiments, computing system 100 may include a computing node connected to model processing device 102 via a communication network, where the computing node includes at least one edge device.

The program code may cause processor 106 to extract model object M including parameters 116 of a machine learning model from the first storage location. Class interface module 112 may configure processor 106 to retrieve and/or read model object M, station object S, and route object R from memory 108 and/or model storage device 110.

The program code may cause processor 106 to generate a model data package. Class data aggregator module 114 may configure processor 106 to package model class M, station class S, and route class R into the model data package. The program code may cause processor 106 to transmit the model data package to the computing node.

In some embodiments, class data aggregator module 114 may further configure processor 106 to inspect machine learning model parameters 116 of model object M when machine learning model parameters 116 are stored on model processing device 102 (e.g., in memory 108, in model storage device 110).

In some embodiments, the model class, the station class, and the route class are configured such that machine learning model parameters 116 are stored in model object M and transmitted in the model package agnostic of plural software environments executing on a local computing system (e.g., model processing device 102) and executing on one or more computing nodes within a communication network.

In some embodiments, model processing device 102 may include a local computing node. Class data aggregator module 114 may configure processor 106 to receive the model package from the local computing node. Class data aggregator module 114 may configure processor 106 to store the model package in model storage device 110.

In some embodiments, the one or more computing nodes may include at least one local computing node local to model processing device 102 and at least one remote computing node remote from model processing device 102 (e.g., within a communication network.

In some embodiments, the one or more computing nodes may include at least one of a first storage device, a computing node executing an Amazon® S3 bucket, a computing node executing a Google® Cloud Platform (GCP) bucket, a computing node storing a container registry associated with the Open Container Initiative (OCI), and a remote computing node. The one or more computing nodes should not be understood as limited to a computing node executing the listed platforms but may include a computing node executing other platforms and/or applications, such as other platforms and/or applications for storing, executing, building, or managing machine learning models, as an example. In some embodiments, the remote computing node may be accessible from model processing device 102 via an API, or, in some instances, Secure Shell Protocol (SSH) (e.g., through user input to model processing device 102).

In some embodiments, model processing device 102 may be implemented in a single computing device. Model processing device 102 may be implemented in one or more computing devices (e.g., a group of servers, such as a group of computing devices, and/or the like) as a distributed and/or decentralized system such that software instructions and/or machine learning models are implemented on different computing devices. In some embodiments, model processing device 102 may be associated with a local computing device, such that model processing device 102 is executed on the local computing device or part of model processing device 102 is executed on the local computing device as part of a distributed and/or decentralized computing system. Alternatively, model processing device 102 may include at least one local computing device executing software instructions for executing, managing, transporting, and/or storing machine learning models.

Model processing device 102 may include processor 106, memory 108, model storage device 110, class interface module 112, class data aggregator module 114, machine learning model parameters 116, and computing node parameters 118. In some embodiments, model processing device 102 may include at least one machine learning model (e.g., associated with machine learning model parameters 116 and stored in model storage device 110). Model processing device 102 may include a computing device (e.g., associated with computing node parameters 118) connected to a network. In some embodiments, model processing device 102 may include components shown in FIG. 1 in a single computing device or computing node. Alternatively, model processing device 102 may include components shown in FIG. 1 distributed across multiple computing devices and/or computing nodes.

Model processing device 102 may include processor 106 (e.g., CPU) and memory 108. Processor 106 may execute software instructions (e.g., compiled program code) for model processing device 102, including software instructions for executing class interface module 112 and class data aggregator module 114 to generate model objects M, station objects S, and route objects R.

In some embodiments, class interface module 112 and class data aggregator module 114 may cause processor 106 to store machine learning model parameters 116 and transmit machine learning model parameters 116. Class interface module 112 and class data aggregator module 114 may cause processor 106 to inspect machine learning model parameters 116 via an API.

Model processing device 102 may include one or more computing devices including one or more processors (e.g., processor 106) configured to execute software instructions. For example, model processing device 102 may include a desktop computer, a portable computer (e.g., laptop computer, tablet computer), a workstation, a mobile device (e.g., smartphone, cellular phone, personal digital assistant, wearable device), a server, and/or other like devices. Model processing device 102 may include a computing device configured to communicate with one or more other computing devices over a network. Model processing device 102 may include a group of computing devices (e.g., a group of servers) and/or other like devices. In some embodiments, model processing device 102 may include a data storage device (e.g., model storage device 110). Alternatively, a data storage device may be separate from model processing device 102 and may be in communication with model processing device 102.

Processor 106 may be implemented in hardware, software, or a combination of hardware and software. For example, processor 106 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 may be coupled to memory 108 via a data bus to transfer data between processor 106 and memory 108.

Memory 108 may include random access memory (RAM), read-only memory (ROM), and/or another type of dynamic or static storage device (e.g., flash memory, magnetic memory, optical memory, etc.) that stores information and/or software instructions for use by processor 106. Memory 108 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 108 from another computer-readable medium or from another device via a communication interface with model processing device 102. When executed, software instructions stored in memory 108 may cause processor 106 to perform one or more processes described herein. Embodiments described herein are not limited to any specific combination of hardware circuitry and software.

Model storage device 110 may include random access memory (RAM), read only memory (ROM), and/or another type of dynamic or static storage device (e.g., flash memory, magnetic memory, optical memory, etc.) that stores information for use by model processing device 102 and/or processor 106. For example, model storage device 110 may store one or more machine learning models. Model storage device 110 may store model objects including machine learning model parameters 116. In some embodiments, model storage device 110 may include a non-transitory computer readable medium that may store information, software, and/or machine learning models related to the operation and use of model processing device 102 and/or processor 106. For example, model storage device 110 may include a hard disk (e.g., a magnetic disk, an optical disk, a magneto-optic disk, a solid-state disk, etc.) and/or another type of computer-readable medium. In some embodiments, model processing device 102 may transmit information to and/or receive information from processor 106.

Model storage device 110 may include a computing device (e.g., a database device) configured to communicate with processor 106 (e.g., via class data aggregator module 114) via a bus or a network environment. For example, model storage device 110 may include a server, a group of servers, and/or other like devices. In some embodiments, model storage device 110 may be associated with one or more computing devices providing interfaces such that a user may interact with model storage device 110 via the one or more computing devices. Model storage device 110 may be in communication with model processing device 102 and/or processor 106 such that model storage device 110 is separate from model processing device 102 and/or processor 106. Alternatively, model storage device 110 may be part (e.g., a component) of model processing device 102 (e.g., as shown in FIG. 1).

In some embodiments, model storage device 110 may include a device capable of storing data (e.g., a database). In some embodiments, model storage device 110 may include a collection of data (e.g., model objects, station objects, and/or route objects) stored and accessed by one or more computing devices and/or computing nodes. Model storage device 110 may include file system storage, cloud storage, in-memory storage, and/or the like. Model storage device 110 may include non-volatile storage (e.g., flash memory, magnetic media), volatile storage (e.g., random access memory (RAM)), or both non-volatile and volatile storage. In some embodiments, model storage device 110 may be hosted (e.g., stored and permitted to be accessed by other computing devices via a network environment) on a computing device and/or computing node separate from model processing device 102. Model storage device 110 may be configured to communicate with processor 106 via class data aggregator module 114. In some embodiments, data storage device 308 may be updated with new machine learning models and/or model objects including machine learning model parameters 116.

As used herein, a module (e.g., software module, software/hardware module, and/or the like) or a service (e.g., software service, microservice, and/or the like) may refer to a loosely-coupled software application and/or a loosely-coupled software service that is designed to facilitate software reuse and high cohesion. In the micro service architecture, software services are fine-grained and protocols are generally lightweight. Software modules and/or services may include interfaces which are treated as a public API. The software module and/or software service may exist and may be reusable (e.g., portable to other software applications and/or systems without requiring changes to the module) independent of other software modules and/or software services.

As used herein, loose-coupling may refer to a design philosophy of developing and/or designing software modules and/or software services such that dependencies on other software and/or hardware components within a system are reduced. Reducing dependencies for software modules in a system may result in easier and more efficient modification to the software modules where modification is required. Reducing dependencies may also facilitate easier and faster reuse of a module, confining specific functions and operations to the module, such that the module may be implemented in various systems to provide a common function. For example, a module may possess a single functional responsibility or a module may offer a single service to the applications and/or systems the module is integrated with. One or more modules may be used in a single application and/or system (e.g., model processing device 102) to provide a desired functionality of that application and/or system. Modules, as used herein, may include hardware, software (e.g., software instructions, program code, etc.), or a combination of both hardware and software. Some modules of model processing device 102 may include class interface module 112 and class data aggregator module 114.

Class interface module 112 may include a component for interfacing processor 106 with memory 108. For example, class interface module 112 may allow processor 106 to interface with memory 108 such that processor 106 may store and/or retrieve objects in memory 108 (e.g., model objects M, station objects S, and route objects R). In some embodiments, class interface module 112 may include a software module (e.g., a module invoked by processor 106 based on program code executed by processor 106) such that functionalities of class interface module 112 may be accessed via an API and such that class interface module 112 may be packaged into a single unit (e.g., a single unit of reusable program code) that may be easily deployed and/or shared. In some embodiments, class interface module 112 may include a combination of hardware and software (e.g., a processor configured to perform specific functions) such that class interface module 112 may perform functions and share data and/or commands with Class interface module 112 may include various functions that may cause processor 106 to interface with memory 108 to manipulate objects (e.g., model objects M, station objects S, and/or route objects R).

As an example, class interface module 112 may be configured to generate model objects M, station objects S, and/or route objects R based on a model class, a station class, and a route class. The model class, the station class, and the route class may serve as templates for structuring and/or generating the model objects M, station objects S, and route objects R respectively. For example, model object M may include plural attributes based on the model class, including but not limited to attributes for a list of machine learning model files, a model identifier (ID), a model size, a model name, and/or a model destination. In some embodiments, the model class may define other attributes and/or parameters of machine learning models that may be allocated as part of generating model object M.

Class interface module 112 may generate model object M based on the model class. Class interface module 112 may allocate memory 108 for storing model object M. In some embodiments, class interface module 112 may be configured to initialize model objects M (e.g., with machine learning model parameters 116) that are generated by class interface module 112. Model object M may include machine learning model parameters 116 of a machine learning model associated with model object M. In some embodiments, class interface module 112 may be configured to store model object M in a first object storage location in memory 108. In some embodiments, model object M may be configured to perform one or more functions based on the model class. For example, model objects M may be configured to convert a data type of machine learning model parameters 116 stored in a model object for transmission (e.g., streaming) or storage in a file system (e.g., to JavaScript Object Notation (JSON)) and/or document database. In some embodiments, class interface module 112 may generate plural model objects M based on the model class.

In some embodiments, class interface module 112 may be configured to cause processor 106 to extract model object M, including machine learning model parameters 116 of a machine learning model, from the first storage location in memory 108. For example, class interface module 112 may extract model object M from memory 108 and may transmit model object M to processor 106 for processing and/or executing the machine learning model. Alternatively, class interface module 112 may extract model object M from memory 108 and may transmit model object M to model storage device 110 (e.g., for local storage). Further, class interface module 112 may extract model object M from memory 108 and may transmit model object M to a remote computing node and/or model registry for storage. In some embodiments, class interface module 112 may configure processor 106 to retrieve model object M, station object S, and route object R from memory 108.

Class interface module 112 may generate station object S based on a station class. Class interface module 112 may allocate memory 108 for storing station object S. Station object S may be associated with at least one computing node in a network. Station object S may include parameters of a computing node. In some embodiments, class interface module 112 may be configured to initialize station objects S (e.g., with local computing node parameters 118) that are associated with a computing node. Class interface module 112 may be configured to store station object S in a second object storage location in memory 108 such that model object M may be configured for storage on the computing node associated with station object S. For example, station object S may model a remote computing node within a network. Memory 108 may store both model object M and station object S such that processor 106 and/or class interface module 112 may reference both model object M and station object S. Processor 106 and/or class interface module 112 may invoke one or more functions of model object M and/or station object S to cause model object M to be transmitted to the remote computing node modeled by station object S for storing model object M.

In this way, station object S models and/or defines a remote computing node for storage of model objects M (e.g., machine learning models) and model object M models and/or defines a machine learning model. Thus, use of model objects M and station objects S as disclosed herein provides for seamless delivery of machine learning models from a first computing node to remote computing nodes without requiring configuration of the machine learning models or remote computing nodes within a network. Model objects M, station objects S, and route objects R allow model processing device 102 to provide flexibility in delivery of machine learning models while also providing a standardized system for machine learning model development, storage, and deployment.

Station object S may include plural attributes based on the station class, including an attribute for a path name of a computing node with which station object S is associated, an attribute for associating station object S with one or more route objects (e.g., route objects R), an attribute to track machine learning models (e.g., model objects M) stored on a computing node (e.g., the computing node with which station object S is associated), and/or an attribute for computing node ID information or login information (e.g., username, password, etc.) for accessing a computing node. In some embodiments, the station class may define other attributes and/or parameters of computing nodes with a network.

In some embodiments, station object S may be configured to perform one or more functions based on the station class. For example, station object S may generate a list of machine learning models stored on a station (e.g., a computing device) associated with station object S. Station object S may be configured to add model objects M to station object S (e.g., by association in memory 108) and station S may add route objects R to station object S (e.g., by association in memory 108). Station object S may push and/or pull machine learning models (e.g., model objects) to and/or from other computing nodes and/or other storage locations. Station object S may be configured to perform various other functions for managing machine learning model parameters 116 and/or model objects. In some embodiments, class interface module 112 may generate plural station objects S based on the station class.

Class interface module 112 may generate route objects R based on a route class. Class interface module 112 may allocate memory 108 for storing route object R. Route object R may be associated with at least one computing node in a network. In some embodiments, route object R may be associated with plural computing nodes (e.g., to model a transmission path from a first computing node to a second computing node). Route object R may include parameters of a transmission path from a source computing device to a destination computing device. For example, route object R may include parameters of a transmission path from model storage device 110 to a remote computing node (e.g., a remote computing node associated with station object S). In some embodiments, route object R may be associated with at least one model registry (e.g., a centralized repository and/or machine learning model storage location on a centralized computing device used for organizing and/or managing machine learning models).

In some embodiments, class interface module 112 may be configured to initialize route objects R (e.g., with local computing node parameters 118) that are associated with at least one computing node. Class interface module 112 may be configured to store route object R in a third object storage location in memory 108 such that model object M is configured for transmission to a computing node associated with route object R (e.g., a remote computing node). For example, route object R may model a transmission path from a source computing node to a destination computing node within a network. Memory 108 may store model object M, station object S, and route object R such that processor 106 and/or class interface module 112 may reference each of model object M, station object S, and route object R. Processor 106 and/or class interface module 112 may invoke one or more functions of model object M, station object S, and/or route object R to cause model object M to be transmitted to a remote computing node modeled by station object S, via a transmission path from a source computing node to the remote computing node modeled by route object R.

In this way, route object R models and/or defines a transmission path for transmission of model objects M (e.g., machine learning models), station object S models and/or defines source computing nodes and destination computing nodes, and model object M models and/or defines a machine learning model. Thus, use of model objects M, station objects S, and route objects R as disclosed herein provides for seamless delivery of machine learning models from a source computing node to a destination computing node without requiring configuration of the machine learning models, remote computing nodes, or transmission paths within a network. Model objects M, station objects S, and route objects R allow model processing device 102 to provide flexibility in delivery of machine learning models while also providing a standardized system for machine learning model development, storage, and deployment.

Route object R may include plural attributes based on the route class, including an attribute for a path name of a source station object (e.g., a first computing node), an attribute for a path name of a destination station object (e.g., a second computing node), and/or an attribute for a model registry (e.g., a model registry name or variable). In some embodiments, the route class may define other attributes and/or parameters of computing nodes within a network that may be allocated when generating route object R.

In some embodiments, route object R may be configured to perform one or more functions based on the route class. For example, route object R may pull and/or download model object M (e.g., a machine learning model) from a computing node (e.g., a remote computing node) or from a model registry hosted on a remote computing node. Route object R may be configured to push and/or transmit model object M (e.g., a machine learning model) to a remote computing node (e.g., a remote computing node). Route object R may be configured to push and/or pull model objects M to and/or from other computing nodes and/or other storage locations. In some embodiments, route object R may be configured to delete model objects M stored in cache memory of a computing device (e.g., a local computing device) when pulling or pushing model objects M. In this way, model objects M and associated machine learning model parameters 116 may be updated on various computing nodes within a network. Route object R may be configured to perform various other functions for managing machine learning model parameters 116 and/or model objects M and modeling transmission paths between computing nodes and/or model registries. In some embodiments, class interface module 112 may generate plural route objects R based on the route class.

As disclosed herein, a module may include software, hardware, or a combination of software and hardware. As an example, where class interface module 112 includes a software module, class interface module 112 may be configured as program code to cause processor 106 to perform various functions. Alternatively, where class interface module 112 includes software and hardware, class interface module 112 may be configured as program code and hardware (e.g., a specially configured processor) to perform various functions independent of and/or in conjunction with processor 106. In this way, class interface module 112 may be configured with its own hardware and/or processor for performing various functions and class interface module 112 may be integrated with model processing device 102 and/or processor 106.

Class data aggregator module 114 may include a component for interfacing processor 106 with model storage device 110. For example, class data aggregator module 114 may allow processor 106 to interface with model storage device 110 such that processor 106 may store and/or retrieve objects in model storage device 110 (e.g., model objects M, station objects S, route objects R, and model data packages). In some embodiments, class data aggregator module 114 may include a component for aggregating data from various other components within a network (e.g., local computing nodes, remote computing nodes, machine learning models and/or machine learning model storage, etc.) such that the aggregated data may be stored within model storage device 110 so the aggregated data may be later assigned to and/or associated with one or more attributes of model object M, station S, and/or route R. For example, class data aggregator module 114 may be configured to cause processor 106 to retrieve data and/or attributes of remote computing nodes and machine learning models available within a network in which model processing device 102 is connected. Class data aggregator module 114 may be configured to cause processor 106 to store the retrieved data and/or attributes in model storage device 110 for later use. Class data aggregator module 114 may be configured to cause processor 106 to interface with model storage device 110 to retrieve the previously stored data and/or attributes and class data aggregator module 114 may be configured to cause processor 106 to assigning and/or associate the data and/or attributes with attributes of model object M, station object S, and/or route object R. Additionally, class data aggregator module 114 may be configured to cause processor 106 to invoke functions of model object M, station object S, and/or route object R by passing data and/or parameters (e.g., as arguments) to functions of model object M, station object S, and/or route object R, where the data and/or parameters is not available in an attribute of an object of an invoked function, but is available in model storage device 110. In some embodiments, class data aggregator module 114 may be configured to store data (e.g., machine learning model parameters 116, computing node parameters 118, etc.) received from networked devices (e.g., remote computing nodes) in model storage device 110. In this way, class data aggregator module 114 may be configured to collect, monitor, and triage data that may be required to build model objects M, station objects S, and/or route objects R to associate these objects with machine learning models, computing nodes, registries, and/or storage locations, and transmission paths.

In some embodiments, class data aggregator module 114 may include a software module (e.g., a module invoked by processor 106 based on program code executed by processor 106) such that functionalities of class data aggregator module 114 may be accessed via an API and such that class data aggregator module 114 may be packaged into a single unit (e.g., a single unit of reusable program code) that may be easily deployed and/or shared. In some embodiments, class data aggregator module 114 may include a combination of hardware and software (e.g., a processor configured to perform specific functions) such that class data aggregator module 114 may perform functions and share data and/or commands with processor 106. Class data aggregator module 114 may include various functions that may cause processor 106 to interface with model storage device 110 to collect, monitor, triage, and assign data elements to objects (e.g., model objects M, station objects S, and/or route objects R). Class data aggregator module 114 may retrieve data from model storage device 110 and class data aggregator module 114 may transmit the data to memory 108 via class interface module 112. In this way, class data aggregator module 114 acts as a data manager while class interface module 112 is the interface to objects in memory 108 where the data may be assigned (e.g., to attributes of objects).

In some embodiments, class data aggregator module 114 may generate a model data package. For example, class data aggregator module 114 may be configured to cause processor 106 to package model class M, station class S, and route class R into a model data package. The model data package may include a data structure including plural objects where the plural objects are associated with each other. The association of objects within the model data package may be based on instructions provided to processor 106 (e.g., by a user of model processing device 102). For example, a first model object M-1 may represent a first machine learning model by including first machine learning model parameters 116. A first station object S-1 may represent a first local computing node on a network (e.g., the local computing node executing model processing device 102), a second station object S-2 may represent a first remote computing node on the network, and a third station object S-3 may represent a second remote computing node on the network. A first route object R-1 may represent a first transmission path from the first local computing node (e.g., station object S-1) to the first remote computing node (e.g., station object S-2) and a second route object R-2 may represent a second transmission path from the first local computing node (e.g., station object S-1) to the second remote computing node (e.g., station object S-3). Processor 106 may receive input instructions (e.g., via input from a user) to transmit the first machine learning model, which may be stored in model storage device 110 and/or memory 108 on the first local computing device, from the first local computing device to the second remote computing device. Upon processing the input instructions, processor 106 may invoke class data aggregator module 114 to generate a model data package including model object M-1 (e.g., representing the first machine learning model and storing data associated therewith), station object S-3 (e.g., representing the destination second remote computing device and storing data therewith), and route object R-2 (e.g., representing the second transmission path from the source first local computing node (e.g., station object S-1) to the destination second remote computing node (e.g., station object S-3)). Once the model data package is created as [M-1, S-3, R-2], processor 106 may execute program code of model processing device 102 that causes processor 106 to transmit model object M-1 and associated machine learning model parameter 116 to the second remote computing node for storage and/or execution.

Machine learning model parameters 116 may include plural data fields and/or parameters related to one or more machine learning models. For example, machine learning model parameters 116 may include a number of files associated with a machine learning model, a date and/or timestamp indicating when a machine learning model was created, a name of a user associated with a machine learning model, a model ID associated with a machine learning model, a name of a machine learning model framework in which the machine learning model was created, a list including names of plural files associated with a machine learning model, a size of a machine learning model, and various other data fields and/or parameters. In some embodiments, machine learning model parameters 116 may include parameters of data types including integers, strings, lists, dictionaries, datetimes, Booleans, and other various data types. Machine learning model parameters 116 may include one or more machine learning model files (e.g., as an object file, binary file, and/or the like) that make up a machine learning model. For example, machine learning model parameters 116 may include one or more files containing layers and/or weights of a machine learning model (e.g., a deep neural network). In some embodiments, machine learning model parameters 116 may be read into an application executing on processor 106 (or another processor of a remote computing node) as a file to be executed for generating one or more signal outputs (e.g., a prediction) based on at least one input. In some embodiments, machine learning model parameters 116 may be read into memory 108 (or another memory module of a remote computing node) such that machine learning model parameters 116 (e.g., machine learning model files) may be executed for generating one or more signal outputs (e.g., a prediction) based on at least one input. Machine learning model parameters 116 may be stored and/or included in model objects M.

Computing node parameters 118 may include plural data fields and/or parameters related to one or more computing nodes. For example, computing node parameters 118 may include a path name, a metadata file name, a name of a model directory, a computing node name, a route dictionary, and various other data fields and/or parameters. In some embodiments, computing node parameters 118 may include parameters of data types including integers, strings, lists, dictionaries, datetimes, Booleans, and other various data types. In some embodiments, computing node parameters 118 may include an environment variable for a local computing node and/or a remote computing node. For example, computing node parameters 118 may include an environment variable of a remote computing device where the environment variable of the remote computing device causes processor 106 to generate a folder (e.g., if a folder does not already exist on the remote computing node) for storing machine learning models on the remote computing node. Computing node parameters 118 may be stored and/or included in station objects S.

As shown in FIG. 1, model processing device 102 (e.g., processor 106 thereof) may perform various functions based on processor 106 being configured to execute program code that, when executed, will cause processor 106 to execute class interface module 112 (e.g., program code for class interface module 112) and class data aggregator module 114 (e.g., program code for class data aggregator module 114). In some embodiments, processor 106 may execute class interface module 112 and class data aggregator module 114 as program code. Alternatively, processor 106 may execute class interface module 112 and class data aggregator module 114 by communicating with a first hardware module corresponding to class interface module 112 and communicating with a second hardware module corresponding to class data aggregator module 114, where class interface module 112 and class data aggregator module 114 are configured with first program code and second program code respectively.

Model processing device 102 (e.g., processor 106 thereof) may perform functions including step 120 of generating a model object based on a model class, step 122 of generating a station object based on a station class, step 124 of generating a route object based on a route class, and step 126 of transmitting the model object to a computing node. For example, model processing device 102 (e.g., processor 106 thereof) may execute program code that causes model processing device 102 to generating model object M based on the model class. Model processing device 102 (e.g., processor 106 thereof) may execute program code that causes model processing device 102 to generate station object S based on the station class. Model processing device 102 (e.g., processor 106 thereof) may execute program code that causes model processing device 102 to generate route object R based on the route class. Model processing device 102 (e.g., processor 106 thereof) may execute program code that causes model processing device 102 to transmit model object M to a remote computing node based on station object S and route object R.

In some embodiments, computing system 100 for managing, transporting, and executing machine learning models in a computing network may include memory 108 configured for storing model objects M, route objects R, and station objects S, model storage device 110 configured for storing machine learning models, and processor 106 configured with class data aggregator module 114 and class interface module 112. Processor 106 may be configured to execute program code that, when executed, may cause processor 106 to execute an API. Processor 106 may be configured to register model data (e.g., machine learning model parameters 116) corresponding to a machine learning model via the API to generate model object M. Model object M may be stored in model storage device 110.

In some embodiments, processor 106 may be configured to push model object M to a container registry executing on a source computing device by transmitting model object M using a registry route object R. The registry route object R may cause model object M to be automatically transmitted to the container registry independent of a configuration of the container registry and/or the source computing device.

In some embodiments, processor 106 may be configured to pull model object M from the container registry executing on the source computing device using a second registry route object R. The second registry route object R may cause model object M to be automatically downloaded to processor 106 of model processing device 102.

In some embodiments, processor 106 may be configured to transmit model object M to a second computing device (e.g., a remote computing node) using a component interface that may cause model object M to be automatically transmitted to the second computing device independent of an operating system executing on the second computing device.

In some embodiments, processor 106 may be configured to write machine learning model parameters 116 associated with model object M to a second model storage device 110 of the second computing device based on a station interface. The station interface may cause the second computing device to store the machine learning model parameters 116 independent of a machine learning model storage application executing on the second computing device. In some embodiments, the second computing device may be remote from model processing device 102. For example, the second computing device may be accessed remotely from model processing device 102, via API calls, SSH, and/or the like depending on a system configuration of model processing device 102.

In some embodiments, processor 106 may be configured to load machine learning model parameters 116 from second model storage device 110 of the second computing device. Class data aggregator module 114 may configure processor 106 to receive a stream of machine learning model parameters 116 as a sequence of bytes to memory 108 of model processing device 102.

The number and arrangement of systems, hardware, and/or modules shown in FIG. 1 is provided as an example. There may be additional systems, hardware, and/or modules, fewer systems, hardware, and/or modules, different systems, hardware, and/or modules, or differently arranged systems, hardware, and/or modules than those shown in FIG. 1. Furthermore, two or more systems, hardware, and/or modules shown in FIG. 1 may be implemented within a single system, hardware, and/or module. A single system, hardware, and/or module shown in FIG. 1 may be implemented as multiple, distributed systems, hardware, and/or modules. Additionally, or alternatively, a set of systems, a set of hardware, and/or a set of modules (e.g., one or more systems, one or more hardware devices, one or more modules) of FIG. 1 may perform one or more functions described as being performed by another set of systems, another set of hardware, or another set of modules of FIG. 1.

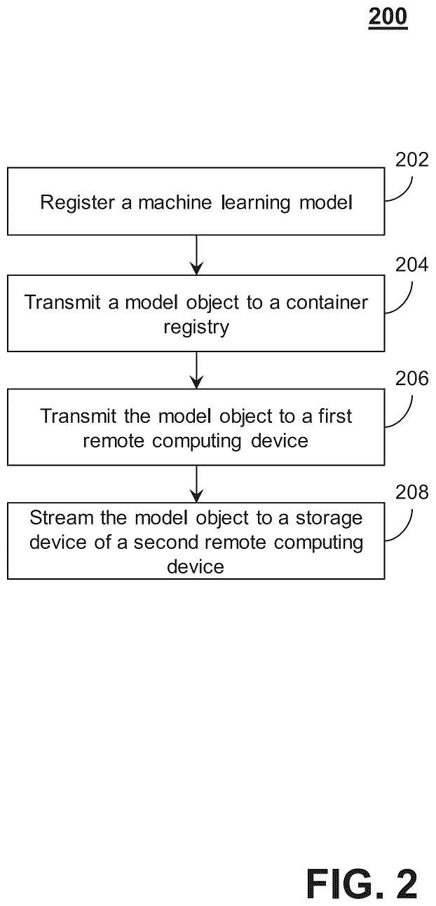

FIG. 2 shows a flow diagram of an exemplary method 200 for managing, transporting, and/or storing machine learning models in a platform-agnostic manner as disclosed herein. In some embodiments, one or more of the functions described with respect to method 200 may be performed (e.g., completely, partially, etc.) by model processing device 102 (e.g., via processor 106). In some embodiments, one or more of the steps of method 200 may be performed (e.g., completely, partially, etc.) by another system, hardware, or module or a group of systems, hardware, or modules separate from or including model processing device 102, such as a client device and/or a separate computing device.

In some embodiments, one or more of the steps of method 200 may be performed in a training phase. A training phase may include a computing environment where a machine learning model, such as a neural model, is being trained (e.g., training environment, model building phase, and/or the like). In some embodiments, one or more of the steps of method 200 may be performed in a testing phase. A testing phase may include a computing environment where a machine learning model, such as a neural model, is being tested and/or evaluated (e.g., testing environment, model evaluation, model validation, and/or the like). In some embodiments, one or more of the steps of method 200 may be performed in a runtime phase. A runtime phase may include a computing environment where a machine learning model, such as a neural model, is active (e.g., deployed, accessible as a service, etc.) and is capable of generating runtime signal outputs (e.g., runtime predictions) based on runtime inputs.

As shown in FIG. 2, at step 202, method 200 may include registering a machine learning model. For example, model processing device 102 (e.g., processor 106 thereof) may register at least one machine learning model. Model processing device 102 may register a machine learning model to generate model object M. Model object M may store model data (e.g., as machine learning model parameters 116) associated with the machine learning model. The machine learning model may have been developed in a first machine learning model framework (e.g., a source framework). In this way, the machine learning model may be said to be coupled to a specific machine learning model framework (e.g., a framework or software application in which the machine learning model was built and/or trained).

In some embodiments, model processing device 102 may register model data (e.g., machine learning model parameters 116) corresponding to a machine learning model via an API. Registering the model data may generate model object M. Model object M may be stored in model storage device 110 for later processing, managing, and/or transporting to a remote computing device. Registering the model data corresponding to the machine learning model may be performed by model processing device 102. In some embodiments, transmitting model object M to a remote computing device may include transmitting model object M from model processing device 102 to the remote computing device over a communication network.

At step 204, method 200 may include transmitting a model object to a container registry. For example, model processing device 102 may transmit model object M to a container registry on a remote computing device. In some embodiments, model processing device 102 may transmit model object M to a first remote computing device. The first remote computing device may execute a container registry, operating system, and/or a machine learning model framework. In some embodiments, model object M may be automatically compatible with the container registry, operating system, and/or machine learning model framework such that model object M (or the machine learning model files associated with model object M) can be stored in the container registry and opened, modified, and/or executed on a machine learning model framework on the first computing device without any required configuration changes to the machine learning model or software environment of the first computing device. For example, model processing device 102 (e.g., processor 106 thereof) may transmit model object M to a second computing device associated with station object S and/or route object R using a component interface that automatically transmits model object M to the second computing device independent of an operating system executing on the second computing device.

At step 206, method 200 may include transmitting the model object to a first remote computing device. For example, model processing device 102 (e.g., processor 106 thereof) may configure the model class, the station class, and the route class such that parameters of the machine learning model (e.g., machine learning model parameter 116) are stored in model object M and transmitted in a model package. The model package may be generated based on model object M, station object S, and route object R. The model package may be transmitted and/or stored agnostic of plural software environments (e.g., operating systems, machine learning model frameworks, and/or the like) executing on the remote computing device and/or executing on one or more computing nodes within a network. In some embodiments, model processing device 102 may transmit model object M to a second computing device using a component interface that automatically transmits model object M to the second computing device independent of an operating system and/or machine learning model framework executing on the second computing device. In this way, model objects including machine learning model parameters 116 and/or files may be agnostic to storage locations, operating systems, and/or machine learning model frameworks executing on remote computing devices.

In some embodiments, model processing device 102 (e.g., processor 106 thereof) may transmit model object M to a first remote computing device. The first remote computing device may execute a destination framework. Model object M may be automatically compatible with the destination framework. In some embodiments, a source framework and a destination framework may include at least one of Open Neural Network Exchange (ONNX), TensorFlow®, PyTorch, Amazon® S3, MLflow, Hugging Face, GCP, and Docker®. In some embodiments, the destination framework is different from the source framework.

At step 208, method 200 may include streaming the model object to a storage device of a remote computing device. For example, model processing device 102 (e.g., processor 106 thereof) may stream model object M to a storage device of a second remote computing device. Model object M may be stored independent of a machine learning model storage application executing on the second remote computing device. In some embodiments, model processing device 102 may stream model object M (and associated machine learning model files) to a second remote computing device such that the second remote computing device may receive the streamed model object M and may execute machine learning model files associated with model object M. In some embodiments, model processing device 102 may stream model object M to an edge device for storing machine learning model files associated with model object M. In this way, model object M and associated machine learning model files may be stored independent of a machine learning model storage application executing on a remote computing device and/or a remote computing node. In some embodiments, the remote computing device may include an edge device. In some embodiments, model object M may be transmitted via a byte stream.

In some embodiments, the storage device of the remote computing device may automatically store model object M using a machine learning model storage application. The machine learning model storage application may include at least one of an Amazon® S3 bucket and a GCP bucket.

Steps of method 200 may be performed in various orders and sequences and are not limited to being performed in the order shown in FIG. 2. Accordingly, steps of method 200 are not limited to any particular order and may be performed by various components, whether model processing device 102 is implemented on a single computing device or multiple, distributed computing devices. Steps of method 200 may also be performed by a single processor of model processing device 102 or by multiple processors of model processing device 102.

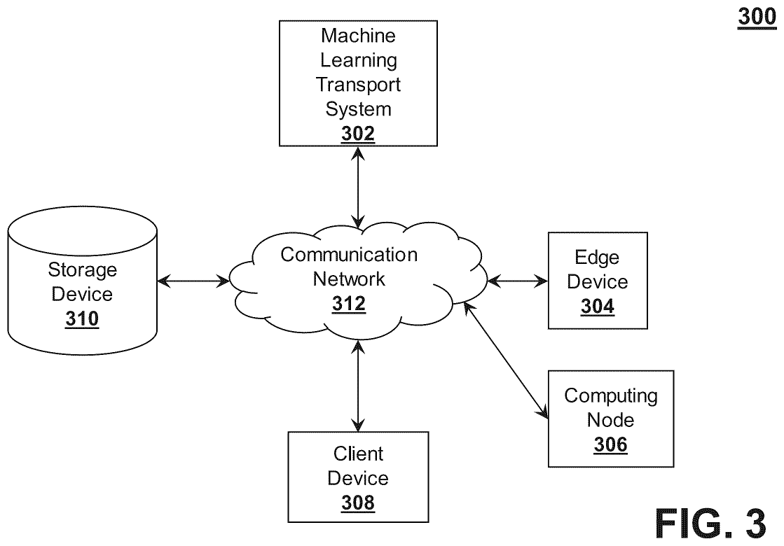

FIG. 3 shows a diagram of an exemplary system environment 300 for managing, transporting, and/or storing machine learning models in a platform-agnostic manner as disclosed herein. The various components of FIG. 3 may be implemented in one or more computing devices (e.g., one or more servers, client devices, user devices, and/or the like) and the one or more computing devices may be connected via a communications network (e.g., the Internet). Each of the components shown in FIG. 3 are described in the context of an exemplary embodiment.

As shown in FIG. 3, embodiments relate to a system environment 300 configured for managing, transporting, and/or storing machine learning models in a platform-agnostic manner in which devices, systems, methods, and/or products described herein may be implemented. System 300 may include machine learning transport system 302, edge device 304, computing node 306, client device 308, storage device 310, and communication network 312. Machine learning transport system 302, edge device 304, computing node 306, client device 308, and storage device 310 may interconnect (e.g., establish a connection to communicate, and/or the like) via wired connections, wireless connections, or a combination of wired and wireless connections.

Machine learning transport system 302 may include one or more computing devices configured to communicate with edge device 304, computing node 306, client device 308, and/or storage device 310 via communication network 312. In some embodiments, machine learning transport system 302 may include one or more computing devices such as computing node 306, client device 308, and/or storage device 310. For example, machine learning transport system 302 may include a group of computing nodes 306 and/or other like devices. In some embodiments, machine learning transport system 302 may be associated with (e.g., operated by) computing node 306 and/or client device 308, as described herein. In some embodiments, machine learning transport system 302 may be the same as or similar to model processing device 102.

Machine learning transport system 302 may be implemented in a single computing device or computing node. Machine learning transport system 302 may be implemented in one or more computing devices (e.g., a group of servers, such as a group of computing devices or computing nodes, and/or the like) as a distributed and/or decentralized system such that software instructions and/or machine learning models are implemented on different computing devices or computing nodes. In some embodiments, machine learning transport system 302 may be associated with a local computing node, such that machine learning transport system 302 is executed on the local computing node or part of machine learning transport system 302 is executed on the local computing device as part of a distributed and/or decentralized computing system. Alternatively, machine learning transport system 302 may include at least one local computing node executing software instructions for executing, managing, transporting, and/or storing machine learning models.

Edge device 304 may include one or more computing devices, such as processors, storage devices, and/or similar computer components that communicate with machine learning transport system 302, computing node 306, and/or client device 308 and/or other computing devices over a network, such as the Internet or private networks and, in some examples, facilitate communication among other edge devices 304, computing nodes 306, and/or client devices 308. In some embodiments, edge device 304 may include, store, and/or execute machine learning models received from computing nodes 306 and/or machine learning transport system 302.

Computing node 306 may include one or more devices capable of receiving information and/or communicating information to machine learning transport system 302, edge device 304, client device 308, and/or storage device 310 via communication network 312. For example, computing node 306 may include a computing device, such as a server, a group of servers, and/or other like devices. In some embodiments, computing node 306 may be associated with a server, a client device, and/or a computing device as described herein.

Client device 308 may include one or more computing devices configured to communicate with machine learning transport system 302, edge device 304, computing node 306, and/or storage device 310 via communication network 312. For example, client device 308 may include a desktop computer (e.g., a client device that communicates with a server), a mobile device, and/or the like. In some embodiments, client device 308 may be associated with a user (e.g., an individual operating client device 308). Client device 308 may access a service (e.g., a cloud service, software-as-a-service, and/or the like) such as machine learning transport system 302 to remotely manage, transport, and/or store machine learning models via model objects M, station objects S, route objects R.

Data storage device 310 may include a database and/or registry for storing one or more machine learning models. In some embodiments, data storage device 310 may include Data storage device 310 may be configured to communicate with machine learning transport system 302, edge device 304, computing node 306, and/or client device 308 via communication network 312. Data storage device 310 may include a device storing data that is accessible by machine learning transport system 302, edge device 304, computing node 306, and/or client device 308. For example, data storage device 310 may store model objects M including machine learning model parameter 116, station objects S, and/or route objects R. In some embodiments, storage device 310 may store model objects M transmitted from machine learning transport system 302 such that model objects M and machine learning model parameters 116 may be stored independent of a storage mechanism provided on data storage device 310. Storage device 310 may be updated with new and/or updated model objects M including machine learning model parameters 116 received from machine learning transport system 302. In this way, machine learning transport system 302 may transmit (e.g., via a network, such as communication network 312) machine learning models via model objects M to computing node 306 and/or storage device 310 for storage.

Communication network 312 may include one or more wired and/or wireless networks. For example, communication network 312 may include a cellular network (e.g., a long-term evolution (LTE®) network, a third generation (3G) network, a fourth generation (4G) network, a fifth generation (5G) network, a code division multiple access (CDMA) network, and/or the like), a local area network (LAN), a wide area network (WAN), a metropolitan area network (MAN), a private network (e.g., a private network associated with machine learning transport system 302), an ad hoc network, an intranet, the Internet, a fiber optic-based network, a cloud computing network, and/or the like, and/or a combination of these or other types of networks.

The number and arrangement of systems, hardware, and/or devices shown in FIG. 3 is provided as an example. There may be additional systems, hardware, and/or devices, fewer systems, hardware, and/or devices, different systems, hardware, and/or devices, or differently arranged systems, hardware, and/or devices than those shown in FIG. 3. Furthermore, two or more systems, hardware, and/or devices shown in FIG. 3 may be implemented within a single system, hardware, and/or device. A single system, hardware, and/or device shown in FIG. 3 may be implemented as multiple, distributed systems, hardware, and/or devices. Additionally, or alternatively, a set of systems, a set of hardware, and/or a set of devices of FIG. 3 may perform one or more functions described as being performed by another set of systems, another set of hardware, or another set of devices of FIG. 3.

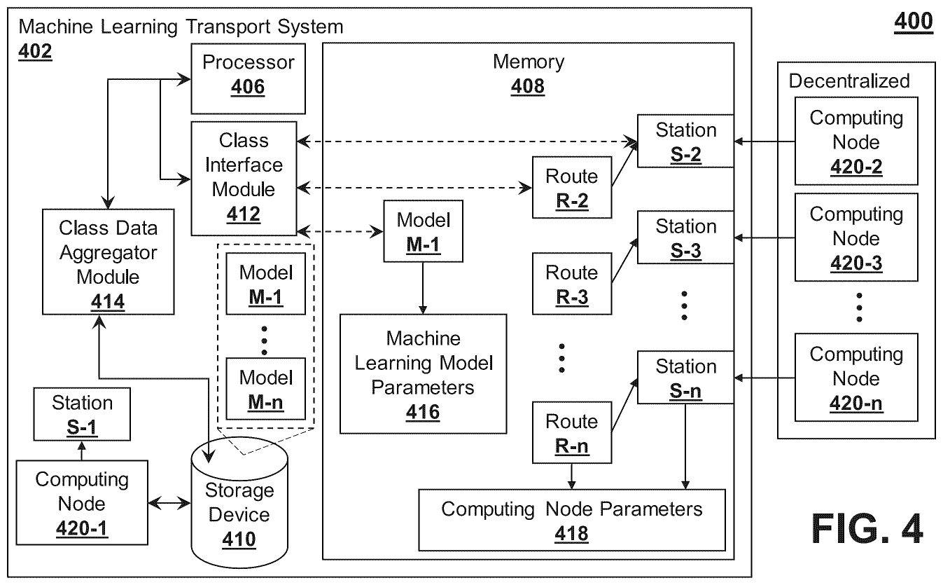

FIG. 4 shows a diagram of an exemplary system configuration 400 for managing, transporting, and/or storing machine learning models in a platform-agnostic and decentralized network as disclosed herein. The various components of FIG. 4 may be implemented in and/or processed by a processor (e.g., a CPU) and/or on any number of distributed processors (e.g., a distributed and/or decentralized computing system) coupled with memory and connected via a communications network. Each of the components shown in FIG. 4 are described in the context of an exemplary embodiment.

As shown in FIG. 4, embodiments relate to a system configuration 400 for managing, transporting, and/or storing machine learning models in a platform-agnostic manner. In some embodiments, system configuration 400 may be configured for executing, managing, transporting, and/or storing machine learning models within a computing network. System configuration 400 may include machine learning transport system 402, processor 406, memory 408, storage device 410, class interface module 412, class data aggregator module 414, machine learning model parameter 416, computing node parameters 418, computing node 420-1 through computing node 420-n (referred to individually as computing node 420 and collectively as computing nodes 420 where appropriate), model objects M-1 to M-n (referred to individually as model object M and collectively as plural model objects M where appropriate), station objects S-1 to S-n (referred to individually as station object S and collectively as plural station objects S where appropriate), and route objects R-1 to R-n (referred to individually as route object R and collectively as plural route objects R where appropriate).

System configuration 400 may include computing system 100 and/or various components shown in computing system 100. For example, machine learning transport system 402 may be the same as or similar to model processing device 102 and/or machine learning transport system 302. Processor 406 may be the same as or similar to processor 106. Memory 408 may be the same as or similar to memory 108. Storage device 410 may be the same as or similar to data storage device 110. Class interface module 412 may be the same as or similar to class interface module 112. Class data aggregator module 414 may be the same as or similar to class data aggregator module 114. Machine learning model parameter 416 may be the same as or similar to machine learning model parameters 116. Computing node parameters 418 may be the same as or similar to computing node parameters 118. Model objects M-1 to M-n may be the same as or similar to model objects M shown in FIG. 1. Station objects S-1 to S-n may be the same as or similar to station objects S shown in FIG. 1. Route objects R-1 to R-n may be the same as or similar to route objects R shown in FIG. 1.

System configuration 400 shows computing node 420-1 through computing node 420-n (referred to individually as computing node 420 and collectively as computing nodes 420 where appropriate) as part of a decentralized system with machine learning transport system 402 which are not expressly shown in FIG. 1. Computing nodes 420 may serve as storage locations and/or destination computing devices for transmitting machine learning models (e.g., via model objects M) from machine learning transport system 402. For example, computing nodes 420 may be connected to machine learning transport system 402 via a communication network. Computing nodes 420 may each execute plural software environments and/or applications. In some embodiments, computing nodes 420 may each execute software environments and/or applications that are generally not compatible with a machine learning model built and/or executed on machine learning transport system 402. However, using machine learning transport system 402 components, such as class interface module 412, class data aggregator module 414, model objects M, station objects S, and route objects R, machine learning models transmitted to computing nodes 420 (e.g., via model objects M) may be automatically compatible with software environments, applications, and/or storage locations on computing nodes 420.

In some embodiments, machine learning transport system 402 may include computing node 420-1 (e.g., as a local computing node). Machine learning transport system 402 may use model objects M, station objects S, and/or route objects R to transport machine learning models from memory 408 to computing node 420-1 for local execution, and/or machine learning transport system 402 may transport machine learning models to/from storage device 410 and/or to/from memory 408 within machine learning transport system 402 as a local computing node 420-1. In this way, class interface module 412, class data aggregator module 414, model objects M, station objects S, and route objects R may be used to transport machine learning models to remote computing devices 420 for management and/or storage or may be used by machine learning transport system 402 to transport machine learning models to local computing node 420-1 and/or storage device 410 local to machine learning transport system 402.

The number and arrangement of systems, hardware, and/or modules shown in FIG. 4 is provided as an example. There may be additional systems, hardware, and/or modules, fewer systems, hardware, and/or modules, different systems, hardware, and/or modules, or differently arranged systems, hardware, and/or modules than those shown in FIG. 4. Furthermore, two or more systems, hardware, and/or modules shown in FIG. 4 may be implemented within a single system, hardware, and/or module. A single system, hardware, and/or module shown in FIG. 4 may be implemented as multiple, distributed systems, hardware, and/or modules. Additionally, or alternatively, a set of systems, a set of hardware, and/or a set of modules (e.g., one or more systems, one or more hardware devices, one or more modules) of FIG. 4 may perform one or more functions described as being performed by another set of systems, another set of hardware, or another set of modules of FIG. 4.

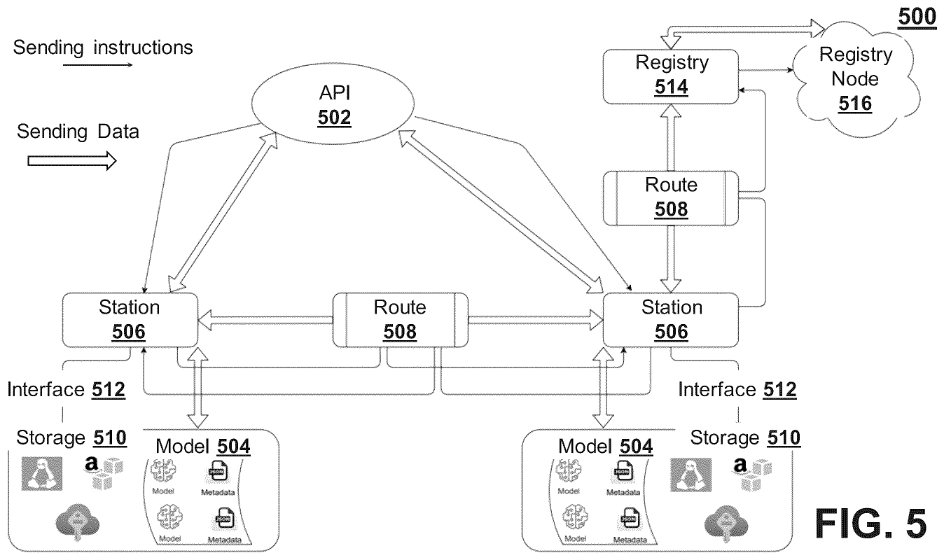

FIG. 5 shows a diagram of an exemplary architecture 500 of components of a computing device and/or system as disclosed herein. For example, architecture 500 may be implemented in model processing device 102, machine learning transport system 302, and/or machine learning transport system 402.

As shown in FIG. 5, embodiments relate to a system architecture 400 for managing, transporting, and/or storing machine learning models in a platform-agnostic manner. In some embodiments, system architecture 400 may be configured for executing, managing, transporting, and/or storing machine learning models within a computing network. System architecture 400 may include API 502, models 504, stations 506, routes 508, storage 510, interfaces 512, registries 514, and registry node 516.

API 502 may serve as an entryway for a user operating model processing device 102 and/or machine learning transport system 402. API 502 may provide various commands and operation for managing, transporting, and/or storing machine learning models on local and/or remote computing nodes. For example, as shown in FIG. 5, API 502 may transmit and receive data to/from stations 506 defined by station objects S. API 502 may transmit instructions to stations 506

Models 504 may include model objects M that include machine learning model files and/or machine learning model parameters 116, 416. Models 504 may be transmitted between stations 506 defined by station objects S via routes 508 defined by route objects R. In this way, routes 508 may serve as transmission paths between stations 506. Models 504 may be stored in storage 510 located on stations 506. Stations 506 may interface with storage 510 via interface 512. In this way, interface 512 on each station 506 may be the same as or similar to class interface module 112, 412 on model processing device 102 and/or machine learning transport system 302, 402.

Stations 506 may be associated with and/or may include various computing nodes within a communication network. For example, computing nodes 420 may each have a station object S associated with computing nodes 420 such that each computing node 420 having a station object S associated with computing device 420 is a station 506 that can transmit and/or receive models 504. In some embodiments, stations 506 may include different system types from other stations 506 for execution of models 504 and/or for storage of models 504.

Routes 508 may be associated with various computing nodes and/or stations 506 within a communication network. For example, route 508 may be associated with at least two stations 506, a source station 506 and a destination station 506. Route 508 may define a transmission path between a first station 506 and a second station 506. Routes 508 may transmit and/or receive data to/from stations 506. Routes 508 may also transmit instructions to stations 506. Routes 508 may each have a route object R associated with each path between stations 506 that defines routes 508 for transmitting machine learning models between stations 506.

Storage 510 may reside on each station 506. Storage 510 may include Amazon® S3 cloud storage, local device storage, Minio, GCP buckets, Azure® Blob Storage, OpenIO Object Storage, or another storage type. Stations 506 may each include different storage solutions.

Registry 514 may include a machine learning model registry executing on a computing node, such as registry node 516. Registry node 516 may include a special computing node that includes registry 514 for storing machine learning models for access by other networked computing nodes. Registry 514 may store machine learning models in a certain format. In this way, using model processing device 102 and/or machine learning transport system 302, 402, machine learning models conforming to model objects M may be stored in registries 514 based on station objects S without regard to a format of registry 514 and/or registry node 516. The machine learning model conforming to model object M may be able to be stored in registry 514 on registry node 516 without requiring additional configuration or formatting.

The number and arrangement of systems, hardware, and/or modules shown in FIG. 5 is provided as an example. There may be additional systems, hardware, and/or modules, fewer systems, hardware, and/or modules, different systems, hardware, and/or modules, or differently arranged systems, hardware, and/or modules than those shown in FIG. 5. Furthermore, two or more systems, hardware, and/or modules shown in FIG. 5 may be implemented within a single system, hardware, and/or module. A single system, hardware, and/or module shown in FIG. 5 may be implemented as multiple, distributed systems, hardware, and/or modules. Additionally, or alternatively, a set of systems, a set of hardware, and/or a set of modules (e.g., one or more systems, one or more hardware devices, one or more modules) of FIG. 5 may perform one or more functions described as being performed by another set of systems, another set of hardware, or another set of modules of FIG. 5.

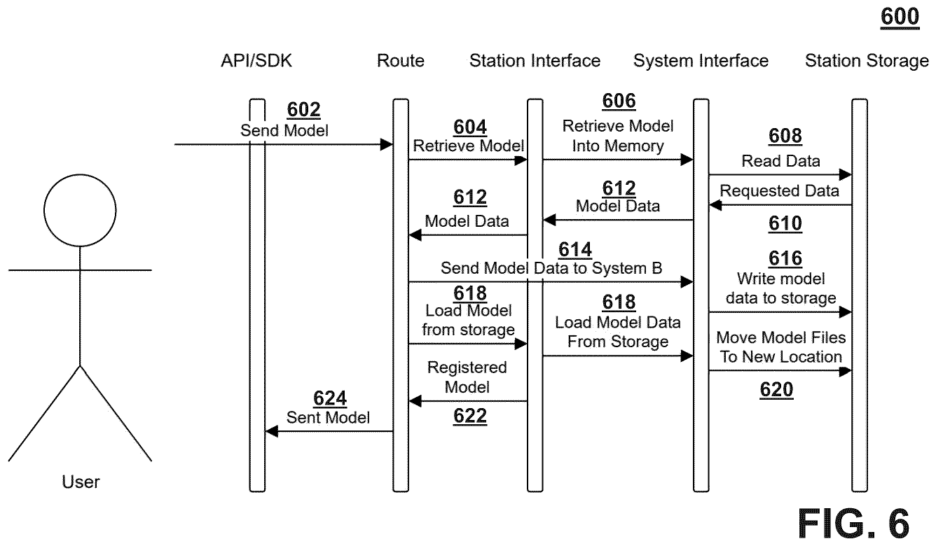

FIG. 6 shows a diagram of an exemplary sequence 600 of steps for saving and/or loading machine learning models in a decentralized network. For example, sequence 600 may be implemented in model processing device 102, machine learning transport system 302, and/or machine learning transport system 402.

As shown in FIG. 6, embodiments relate to a sequence 600 of steps for managing, transporting, and/or storing machine learning models in a platform-agnostic manner. In some embodiments, sequence 600 may be implemented for executing, managing, transporting, and/or storing machine learning models within a computing network. Sequence 600 may include sending a machine learning model 602, retrieving a machine learning model 604, retrieving a machine learning model into memory 606, reading data into storage at a station 608, receiving requested data 610, receiving model data 612, sending model data to a second computing system 614, writing model data to storage 616, loading a machine learning model from storage 618, moving machine learning model files to a new location 620, sending a registered model 622, and completing sending of a machine learning model 624.

Step 602 of sequence 600 may include sending a machine learning model. At step 602, model processing device 102 and/or machine learning transport system 302, 402 may receive a command via API 502. Model processing device 102 and/or machine learning transport system 302, 402 may then process the command via API 502 and may begin the model transport process by finding route object R including a source computing node and a destination computing node for the machine learning model (e.g., by processing parameters passed via API 502).

Step 604 of sequence 600 may include retrieving a machine learning model. For example, station 506 may retrieve a machine learning model (e.g., model 504, via model object M) from model processing device 102 and/or machine learning transport system 302, 402 transmitted via route 508 (e.g., via route object R). Station 506 may retrieve the machine learning model from route 508 via a station interface.

Step 606 of sequence 600 may include retrieving a machine learning model into memory. For example, station 506 may retrieve a machine learning model (e.g., model 504, via model object M) into memory of station 506 for storage. The machine learning model may be retrieved from route 508 via a station interface. The system interface (e.g., interface 512) to station 506 memory may retrieve the machine learning model via the station interface to route 508.

Step 608 of sequence 600 may include reading data into storage at a station. For example, station 506 may read the machine learning model data from memory into storage 510 associated with station 506.

Step 610 of sequence 600 may include receiving requested data. For example, the system interface may retrieve machine learning model data (e.g., machine learning model parameters 116) from storage 510 into memory of station 506.

Step 612 of sequence 600 may include receiving model data at a station interface. For example, a station interface of station 506 may receive model data of a machine learning model (e.g., machine learning model parameters 116) from memory of station 506 for transmitting to route 508. The station interface may then forward machine learning model data to route 508.

Step 614 of sequence 600 may include sending model data to a second computing system. For example, route 508 may interface with a second computing node (e.g., a second station 506) via a system interface to send machine learning model data to another station 506 or to a local computing node (e.g., model processing device 102, machine learning transport system 302, 402).

Step 616 of sequence 600 may include writing model data to storage. For example, the system interface for station 506 (e.g., remote computing node or local computing node) may write the machine learning model data to storage 510 associated with station 506.

Step 618 of sequence 600 may include loading a machine learning model from storage. For example, route 508 may load machine learning model data from storage 510 associated with station 506 for moving the machine learning model files to a new storage location on another station 506.

Step 620 of sequence 600 may include moving machine learning model files to a new location. For example, route 508 may move machine learning model files to new storage 510 n another station 506 (e.g., a remote computing node or a local computing node).

Step 622 of sequence 600 may include sending a registered model. For example, route 508 may load a registered machine learning model from storage 510 associated with station 506. In some embodiments, route 508 may load the registered machine learning model from registry 514 on registry node 516 for transmitting to a local station 506 (e.g., model processing device 102, machine learning transport system 302, 402).

Step 624 of sequence 600 may include completing sending of a machine learning model. For example, route 508 may complete transmission of a machine learning model (e.g., model 504, via model object M) to station 506 (e.g., a remote computing node or a local computing node). In some embodiments, a user operating a client device (e.g., client device 308) may receive a machine learning model delivered via route 508 from a remote station 506.

Steps of sequence 600 may be performed in various orders and sequences and are not limited to being performed in any particular order. Accordingly, steps of sequence 600 are not limited to any particular order and may be performed by various components, whether model processing device 102 and/or machine learning transport system 302, 402 are implemented on a single computing device or multiple, distributed computing devices. Steps of sequence 600 may also be performed by a single processor of model processing device 102 and/or machine learning transport system 302, 402 or by multiple processors of model processing device 102 and/or machine learning transport system 302, 402.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory; the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

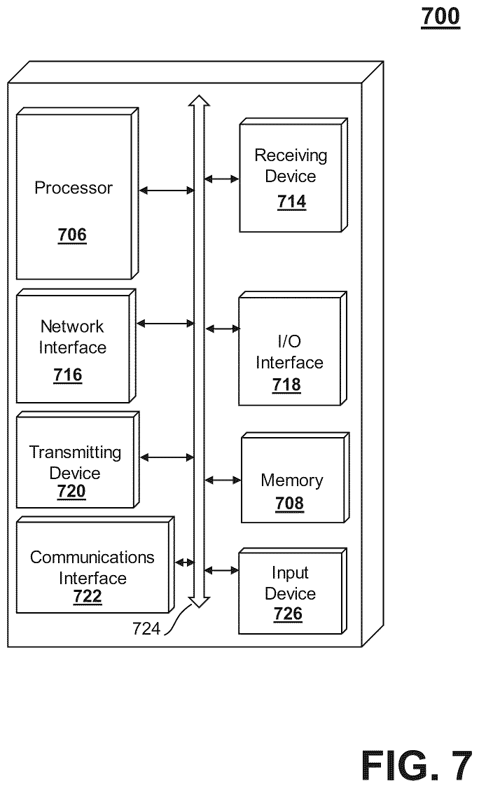

FIG. 7 shows a diagram of example components of a computing device or system 700 as disclosed herein. Computing device 700 (and/or at least one component of computing device 700) may correspond to at least one of model processing device 102, processor 106, memory 108, and/or model storage device 110 in FIG. 1 and/or at least one of machine learning transport system 302, 402, edge device 304, computing device 306, client device 308, storage device 310, and/or communication network 312 in FIG. 3. In some embodiments, such systems or devices in FIGS. 1-5 may include at least one computing device 700 and/or at least one component of computing device 700. The number and arrangement of components shown in FIG. 7 are provided as an example. In some embodiments, computing device 700 may include additional components, fewer components, different components, or differently arranged components than those shown in FIG. 7. Additionally, or alternatively, a set of components (e.g., one or more components) of computing device 700 may perform one or more functions described as being performed by another set of components of computing device 700.

Computing system or device 700 may include processor 706, memory 708, receiving device 714, network interface 716, input/output (I/O) interface 718, transmitting device 720, communications interface 722, communication infrastructure 724, and input device 726. Memory 708 may be the same as or similar to memory 108 as disclosed herein. Processor 706 may be the same as or similar to processor 106 as disclosed herein. Communications infrastructure 724 may be the same as or similar to communication network 312.

Memory 708 can be configured for storing program code for at least one machine learning model. Memory 708 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 700 via a mobile communication network. According to an exemplary embodiment, an external memory device can be used in place of any resident memory devices. Data stored in system 700 may be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by processor 706, and software or program code used by processor 706 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

Receiving device 714 may be a combination of hardware and software components configured to receive data samples from the mobile network or database. According to exemplary embodiments, receiving device 714 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 714 can be an input device for receiving signals and/or data samples formatted according to 3GPP protocols and/or standards. Receiving device 714 can be connected to other devices via a wired or wireless network or via a wired or wireless direct link or peer-to-peer connection without an intermediate device or access point. The hardware and software components of receiving device 714 can be configured to receive the data from the mobile network according to one or more communication protocols and data formats. For example, receiving device 714 can be configured to communicate over a network, which may include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 714 can be configured to identify parts of the received data via a header and parse the data signal and/or data packet into small frames (e.g., bytes, words) or segments for further processing at processor 706.

Processor 706 can be configured for executing the program code stored in memory 708. Upon execution, the program code causes processor 706 to perform the functions at a node on the mobile communication network or remote computing device (e.g., server, computer, etc.) of the user and execute a machine learning model (e.g., ensemble machine learning model 112) for managing, transporting, and/or storing machine learning models on local computing nodes or remote computing nodes according to the exemplary embodiments described herein. Processor 706 can be a special purpose or a general purpose computing device encoded with program code or software for performing the exemplary functions and/or features disclosed herein. According to exemplary embodiments of the present disclosure, processor 706 can include a CPU. The CPU can be connected to the communications infrastructure including a bus, message queue, or network, multi-core message-passing scheme, for communicating with other components of computing system 700, such as memory 708, input device 726, communications interface 722, and I/O interface 718. The CPU can include one or more processors such as a microprocessor, microcomputer, programmable logic unit or any other suitable hardware computing devices as desired.

I/O interface 718 can be configured to receive the signal from processor 706 and generate an output suitable for a peripheral device via a direct wired or wireless link. I/O interface 718 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 720 can be configured to receive data from processor 706 and assemble the data into a data signal and/or data packets according to the specified communication protocol and data format of a peripheral device or remote device to which the data is to be sent. Transmitting device 720 can include any one or more of hardware and software components for generating and communicating the data signal over communications infrastructure 724 and/or via a direct wired or wireless link to a peripheral or remote device. Transmitting device 720 can be configured to transmit information according to one or more communication protocols and data formats as discussed in connection with receiving device 714.

According to exemplary embodiments described herein, memory 708 and processor 706 can store and/or execute computer program code for performing the specialized functions described herein. It should be understood that the program code can be stored on a non-transitory computer usable medium, such as memory devices for the system 700 (e.g., computing device), which may be memory semiconductors (e.g., DRAMs, etc.) or other tangible non-transitory means for providing software to system 700. The computer programs (e.g., computer control logic) or software may be stored in memory devices (e.g., device memory 708) resident on/in system 700. The computer programs may also be received from external storage devices and/or network storage locations via a communications interface. Such computer programs, when executed, may enable system 700 to implement the present methods and exemplary embodiments discussed herein. Accordingly, such computer programs may represent controllers of system 700. Where the present disclosure is implemented using software, the software may be stored in a computer program product or non-transitory computer readable medium and loaded into system 700 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling system 700 to perform the functions disclosed herein. It will be apparent to persons having skill in the relevant art that such processes result in system 700 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A computing system for delivery of machine learning models within a computing network, the computing system comprising:
memory including object storage locations configured to store model objects, route objects, and station objects;
a model storage device configured for storing machine learning models; and
a processor configured with a class interface module and a class data aggregator module, the processor configured to execute program code that, when executed, will cause the processor to:
execute the class interface module and the class data aggregator module to:
generate a model object based on a model class, the model object including parameters of a machine learning model, wherein the class data aggregator module configures the processor to store the parameters of the machine learning model in the model object and wherein the class interface module configures the processor to store the model object in a first object storage location in the memory;
generate a station object based on a station class, the station object including parameters of a computing node, wherein the class data aggregator module configures the processor to store the parameters of the computing node in the station object and wherein the class interface module configures the processor to store the station object in a second object storage location in the memory such that the model object is configured for storage on the computing node;
generate a route object based on a route class, the route object including parameters of a transmission path from the model storage device to the computing node, wherein the class data aggregator module configures the processor to store the parameters of the transmission path in the route object and wherein the class interface module configures the processor to store the route object in a third object storage location in the memory such that the model object is configured for transmission to the computing node;
extract the model object including the parameters of the machine learning model from the first storage location, wherein the class interface module configures the processor to retrieve the model object, the station object, and the route object;
generate a model data package, wherein the class data aggregator module configures the processor to package the model class, station class, and route class into the model data package; and
transmit the model data package to the computing node.

2. The computing system of claim 1, wherein the model class, the station class, and the route class are configured such that the parameters of the machine learning model are stored in the model object and transmitted in the model package agnostic of plural software environments executing on the computing system and executing on one or more computing nodes.

3. The computing system of claim 2, wherein the one or more computing nodes include at least one local computing node local to the first model processing device and at least one remote computing node remote from the first model processing device.

4. The computing system of claim 1, wherein the class data aggregator module further configures the processor to inspect the parameters of the machine learning model when the parameters are stored on the computing device.

5. The computing system of claim 4, wherein the class interface module and the class data aggregator module configure the at least one processor to:
store the parameters of the machine learning model, transmit the parameters of the machine learning model, and inspect the parameters of the machine learning model via an application programming interface (API).

6. The computing system of claim 1 including a local computing node, wherein the class data aggregator module configures the processor to:
receive the model package from the computing node; and
store the model package in the model storage device.

7. The computing system of claim 2, wherein the one or more computing nodes include at least one of the first storage device, a computing node executing an Amazon® Simple Storage Service (S3) bucket, a computing node executing a Google® Cloud Platform (GCP) bucket, a computing node storing a container registry associated with the Open Container Initiative (OCI), and a remote computing node.

8. The computing system of claim 7, wherein the class interface module is configurable by a user via the processor to generate additional computing nodes using the station class.

9. The computing system of claim 7, wherein the remote computing node is accessible from the first model processing device via Secure Shell Protocol (SSH).

10. The computing system of claim 1, wherein the computing system includes at least one edge device.

11. A system for managing, transporting, and executing machine learning models in a computing network, comprising:
a first model processing device;
memory configured for storing model objects, route objects, and station objects;
a model storage device configured for storing machine learning models; and
a processor configured with a class data aggregator module and a class interface module, the processor configured to execute program code that, when executed, will cause the processor to:
execute an application programming interface (API);
register model data corresponding to a machine learning model via the API to generate a model object, wherein the model object is stored in the first storage device;
push the model object to a container registry executing on a source computing device by transmitting the model object using a first registry route that automatically transmits the model object to the container registry independent of a configuration of the container registry;
pull the model object from the container registry executing on the source computing device using a second registry route, wherein the second registry route automatically downloads the model object to at least one processor of the first model processing device;
transmit the model object to a second computing device using a component interface that automatically transmits the model object to the second computing device independent of an operating system executing on the second computing device; and
write the model data associated with the model object to a second model storage device of the second computing device based on a station interface, wherein the station interface causes the second computing device to store the model data independent of a machine learning model storage application executing on the second computing device.

12. The system of claim 11, wherein the second computing device is remote from the first model processing device and the second computing device is accessed using Secure Shell Protocol (SSH) on the first model processing device.

13. The system of claim 11, wherein the model data includes a model identifier (ID), a list of one or more model files, a model name, and a model version.

14. The system of claim 11, wherein the program code, when executed, will cause the processor to:
load the model data from the second storage device of the second computing device, wherein the class data aggregator module configures the processor to receive a stream of the model data as a sequence of bytes to the memory of the first model processing device.

15. A method for managing and transporting machine learning models in a decentralized computing network, the method comprising:
registering a machine learning model to generate a model object storing model data associated with the machine learning model, wherein the machine learning model was developed in a source framework;
transmitting the model object to a container registry;
transmitting the model object to a first remote computing device, the first remote computing device executing a destination framework, wherein the model object is automatically compatible with the destination framework; and
streaming the model object to a storage device of a second remote computing device, wherein the model object is stored independent of a machine learning model storage application executing on the second remote computing device.

16. The method of claim 15, wherein the model object is transmitted via a byte stream.

17. The method of claim 15, wherein registering the machine learning model is performed by a first model processing device, and transmitting the model object to a remote computing device includes transmitting the model object from the first model processing device to the remote computing device over a communication network.

18. The method of claim 15, wherein the source framework and the destination framework include at least Open Neural Network Exchange (ONNX), TensorFlow, PyTorch, Amazon® Simple Storage Service (S3), MLflow, Hugging Face, Google® Cloud Platform (GCP), and Docker and wherein the destination framework is different from the source framework.

19. The method of claim 15, wherein the remote computing device includes an edge device.

20. The method of claim 15, wherein the storage device of the remote computing device automatically stores the model object using the machine learning model storage application, the machine learning storage application including at least one of an Amazon® Simple Storage Service (S3) bucket and a Google® Cloud Platform (GCP) bucket.
